(19) United States
(12) Patent Application Publication
(10) Pub. No.: US 2013/0050617 A1
(43) Pub. Date: Feb. 28, 2013

(54) DISPLAY APPARATUS

(71) Applicants: Hee-Keun Lee, Suwon-si (KR); Seung Ju Lee, Hwaseong-si (KR); Haeju Yun, Hwaseong-si (KR); Sangil Kim, Yongin-si (KR); Dong-min Lee, Suyeong-gu (KR)

(72) Inventors: Hee-Keun Lee, Suwon-si (KR); Seung Ju Lee, Hwaseong-si (KR); Haeju Yun, Hwaseong-si (KR); Sangil Kim, Yongin-si (KR); Dong-min Lee, Suyeong-gu (KR)

(21) Appl. No.: 13/352,778

(22) Filed: Jan. 18, 2012

(30) Foreign Application Priority Data
Aug. 23, 2011 (KR) 10-2011-0084136

(51) Int. Cl. G02F 1/1335

(52) U.S. Cl. 349/96

(57) ABSTRACT

A display apparatus including a display panel, first and second polarizing films, and first and second stress relieving members. The first stress relieving member is interposed between the first polarizing film and the display panel to balance a restoring force from the first polarizing film, and the second stress relieving member is interposed between the second polarizing film and the display panel to relieve a restoring force from the second polarizing film.

### CROSS-REFERENCE TO RELATED APPLICATIONS

This U.S. non-provisional patent application claims priority under 35 U.S.C. §119 to Korean Patent Application No. 10-2011-0084136, filed on Aug. 23, 2011, in the Korean Intellectual Property Office, the entire contents of which are hereby incorporated by reference.

### TECHNICAL FIELD

Embodiments of the inventive concepts relate generally to a display apparatus, and more particularly, to a display apparatus configured to substantially prevent deformation thereof.

### DISCUSSION OF RELATED ART

Generally, a display apparatus, such as a liquid crystal display device or an electrophoretic display device according to the present inventive concept is configured to display an image using external light. The display apparatus may include one or more polarizing films disposed on incident and emitting surfaces thereof in order to control an optical property of the external light incident thereto and to improve display characteristics of a display image emitted therefrom.

The polarizing film is uni-axially or bi-axially stretched by using a stretching process and is then incorporated into the display panel. In one embodiment, a stress may be exerted on the display panel, due to a restoring force of the stretched polarizing film. For example, a display panel, having a thin substrate may be deformed by the restoring force of the stretched polarizing film.

### SUMMARY

Embodiments of the present inventive concepts provide a display apparatus configured to substantially prevent the occurrence of deformation thereof.

According to example embodiments of the inventive concepts, a display apparatus can include a display panel displaying an image, a first polarizing film disposed on one surface of the display panel, a second polarizing film disposed on other surface of the display panel, a first stress relieving member interposed between the first polarizing film and the display panel to counteract the restoring force from the first polarizing film, and a second stress relieving member interposed between the second polarizing film and the display panel to counteract the restoring force from the second polarizing film.

In some embodiments, the display apparatus can further include a third stress relieving member disposed on a surface of the first polarizing film opposite the display panel, and a fourth stress relieving member disposed on a surface of the second polarizing film opposite the display panel.

In certain embodiments, the first to fourth stress relieving members each independently have a thickness ranging from about 30 μm to about 250 μm.

In other embodiments, the first and second stress relieving members are thinner than the third and fourth stress relieving members. For example, the first stress relieving member can have a thickness less than half that of the third stress relieving member and the second stress relieving member has a thickness less than half that of the fourth stress relieving member.

In some embodiments, the first and second stress relieving members are adhesive layers including a pressure sensitive adhesive material, and have an adhesive strength of 12 gf/mm or less.

According to example embodiments of the inventive concepts, a display apparatus can include a display panel displaying an image, a first polarizing film disposed on one surface of the display panel, a second polarizing film disposed on other surface of the display panel, a first stress relieving member disposed on a surface of the first polarizing film opposite to the display panel, and a second stress relieving member disposed on a surface of the second polarizing film opposite to the display panel.

In certain embodiments, the first and second stress relieving members are configured to generate resistive forces against the restorative forces generated in the first and second polarizing films, respectively.

In certain other embodiments, in plan view, the first stress relieving member includes a thin film stretched in the plane of the film along a direction perpendicular to a stretching direction of the first polarizing film; and the second stress relieving member includes a thin film stretched in the plane of the film along a direction perpendicular to the stretching direction of the second polarizing film.

### BRIEF DESCRIPTION OF THE DRAWINGS

Example embodiments will be more clearly understood from the following brief description taken in conjunction with the accompanying drawings. FIGS. 1 through 7 represent non-limiting, example embodiments as described herein.

FIG. 1 is a sectional view of a display apparatus according to example embodiments of the inventive concepts;

FIG. 2 is a sectional view of a display apparatus according to other example embodiments of the inventive concepts;

FIGS. 3 through 6 show display apparatus according to still other example embodiments of the inventive concepts; and

FIG. 7 is a graph showing deformation characteristics measured from display apparatus.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

The present invention is explained in detail below with reference to the accompanying drawings.

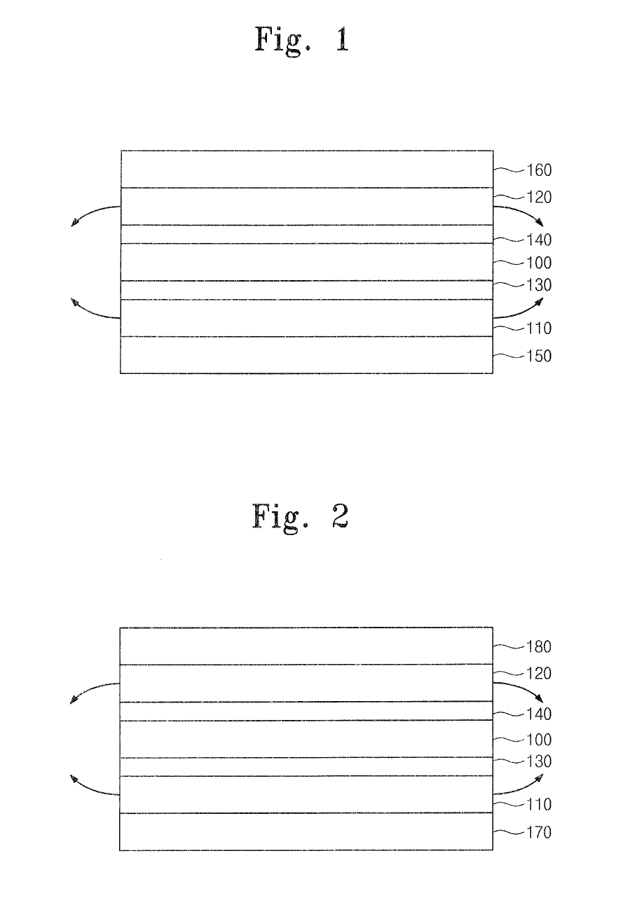

FIG. 1 is a sectional view of a display apparatus according to example embodiments of the inventive concepts.

Referring to FIG. 1, in certain embodiments, the display apparatus includes a display panel 100 displaying an optical image, a first polarizing film 110 disposed on one surface of the display panel 100, a second polarizing film 120 disposed on other surface of the display panel 100, and first and second stress relieving members 130 and 140 interposed between the display panel 100 and the first and second polarizing films 110 and 120. Furthermore, a third stress relieving member 150 may be provided on a surface of the first polarizing film 110 opposite the first stress relieving member 130, and a fourth stress relieving member 160 may be provided on a surface of the second polarizing film 120 opposite the second stress relieving member 140.

The display panel 100 may be one of various display panels, such as a liquid crystal display (LCD) panel or an electrophoretic display panel (EDP). For the sake of simplicity, the description that follows will refer to an example of the present embodiment in which the liquid crystal display panel is used for the display panel 100.

The display panel 100 may be provided to have a rectangular shape with a long side and a short side. The display panel 100 (not shown) may include an array substrate, an opposite substrate facing the array substrate, and a liquid crystal layer interposed between the array and opposite substrates. In certain embodiments, the array and opposite substrates may be an insulating glass substrate. In other embodiments, the array and opposite substrates may be an insulating thin film substrate, which can be used, for example, for mobile electronic devices so that the mobile electronic devices can be thin.

The array substrate (not shown) may be configured to have a plurality of pixels arranged in a matrix. Each of the pixels may include a pixel electrode, and a gate line and a data line may be disposed near the pixel electrode. The gate and data lines may extend along first and second directions crossing each other, respectively. In some embodiments, the first direction may be, for example, parallel to one side of the array substrate. The array substrate may be configured to have a plurality of thin-film transistors, each of which is electrically connected to the gate and data lines and the pixel electrode in the corresponding one of the pixels. The thin-film transistor may be configured to control a switching operation of an operating signal provided to the corresponding pixel electrode. In addition, a driving circuit may be provided at one side of the array substrate. The driving circuit can be configured to receive various signals from the external device and output signals for operating the display panel 100 in response to the received signals.

The opposite substrate may include a RGB color filter, which is disposed on a surface thereof to display a specific color, and a common electrode, which is disposed on the RGB color filter to face the pixel electrode. The RGB color filter may be formed using a thin-film process. Exemplary embodiments of the inventive concepts are not limited to the previously described example of the embodiments of the invention, in which the color filter is disposed on the opposite substrate. For example, the color filter can be formed on the array substrate.

The liquid crystal layer may be distorted in respond to voltages applied to the pixel electrode and the common electrode to have a specific orientation. This enables to change transmission of a light that is incident from a backlight unit (not shown) or an external space, such that the display panel 100 can display an image.

The first and second polarizing films 110 and 120 may be a uni-axially or bi-axially stretched thin film of, for example, polyvinyl alcohol (PVA). The stretched property of the first and second polarizing films 110 and 120 may be controlled to adjust refractive indices of the first and second polarizing films 110 and 120 and to align an polarization axis of each of the first and second polarizing films 110 and 120. For the sake of simplicity, the description that follows will refer to an example of the present embodiment in which uni-axially stretched thin films are used for the first and second polarizing films 110 and 120.

The first to fourth stress relieving members 130, 140, 150 and 160 may include at least one material selected from the group consisting of triacetyl cellulose, cycloolefin polymer, and equivalents thereof.

The first to fourth stress relieving members 130, 140, 150 and 160 may have thicknesses ranging from 30 μm to 250 μm. For example, if the first to fourth stress relieving members 130, 140, 150 and 160 have thicknesses of 250 μm or more, a brightness property of the display apparatus may be reduced. Alternatively, if the first to fourth stress relieving members 130, 140, 150 and 160 have thicknesses of 30 μm or less, the first to fourth stress relieving members 130, 140, 150 and 160 may be inadequate to provide a countering force against the first and second polarizing films 110 and 120.

In some embodiments, the first and second stress relieving members 130 and 140 can have thicknesses less than that of the third and fourth stress relieving members 150 and 160. For example, the thicknesses of the first and second stress relieving members 130 and 140 may be equivalent to half those of the third and fourth stress relieving members 150 and 160.

A restoring force, which may result from the first and second polarizing films 110 and 120 in the stretched state, can be effectively relieved in the case wherein the first and second stress relieving members 130 and 140 are interposed between the first and second polarizing films 110 and 120 and the display panel 100, as compared with the case wherein only the third and fourth stress relieving members 150 and 160 are provided as stress relieving elements.

Furthermore, in the case in which thicknesses of the first and second stress relieving members 130 and 140 are different from those of the third and fourth stress relieving members 150 and 160, it is possible to control the direction of the deforming force resulting from a deformation of the first and second polarizing films 110 and 120.

For example, when the first stress relieving member 130 is thinner than the third stress relieving member 150, the restoring force of the stretched first polarizing film 110 may serve as a deforming force exerted toward the display panel 100. In more detail, the restoring force of the stretched first polarizing film 110 is less relieved by the first stress relieving member 130 than by the third stress relieving member 150 (i.e., asymmetrically). As a result, the first polarizing film 110 may exert the deforming force on the display panel 100.

In addition, when the second stress relieving member 140 is thinner than the fourth stress relieving member 160, the restoring force of the stretched second polarizing film 120 may serve as a deforming force exerted toward the display panel 100.

Since both of the deforming forces from the first and second polarizing films 110 and 120 are exerted on the display panel 100 (i.e., antiparallel with each other), the deforming forces from the first and second polarizing films 110 and 120 may cancel each other out.

In the display apparatus according to example embodiments of the inventive concepts, the first and third stress relieving members 130 and 150 may be provided on both sides of the first polarizing film 110, and the second and fourth stress relieving members 140 and 160 may be provided on both sides of the second polarizing film 120. In some embodiments, the first and second stress relieving members 130 and 140 can be thinner than the third and fourth stress relieving members 150 and 160, respectively. In this case, the deforming forces from the first and second polarizing films 110 and 120 can be controlled to be oriented toward the display panel 100, such that they cancel each other out. This prevents the display panel 100 from being deformed.

FIG. 2 is a sectional view of a display apparatus according to other example embodiments of the inventive concepts.

Referring to FIG. 2, a display apparatus can include a display panel 100, first and second polarizing films 110 and 120 disposed on both surfaces of the display panel 100, first and second stress relieving members 130 and 140 interposed between the display panel 100 and the first and second polarizing films 110 and 120. Furthermore, a first stress offsetting layer 170 may be provided on a surface of the first polarizing film 110 opposite the first stress relieving member 130 to serve as a third stress relieving member, and a second stress offsetting layer 180 may be provided on a surface of the second polarizing film 120 opposite the second stress relieving member 140 to serve as a fourth stress relieving member. In some embodiments, the first and second stress relieving members 130 and 140 may be thinner than the first and second stress offsetting layers 170 and 180. For example, the first stress relieving member 130 may be formed to have a thickness less than half that of the first stress offsetting layer 170, and the second stress relieving member 140 may be formed to have a thickness less than half that of the second stress offsetting layer 180.

The first and second stress offsetting layers 170 and 180 may be formed of un-stretched transparent films. For example, the first and second stress offsetting layers 170 and 180 may include at least one transparent film selected from the group consisting of polyethylene terephthalate (PET) materials, acrylic materials, and equivalents thereof.

The first and second stress offsetting layers 170 and 180 may be formed by coating or depositing a transparent material. For example, the first and second stress offsetting layers 170 and 180 may be organic transparent layers (for example, formed of at least one selected from the group consisting of polyimide (PI), parylene, polymethly methacrylate (PMMA), polyvinylalcohol (PVA), polyvinylphenol (PVP), and equivalents thereof) coated on the first and second polarizing films 110 and 120.

In addition, the first and second stress offsetting layers 170 and 180 may be transparent deposition layers (for example, formed of at least one selected from the group consisting of amorphous silicon (a-Si), silicon nitride (SiNx), and equivalents thereof) deposited on the first and second polarizing films 110 and 120.

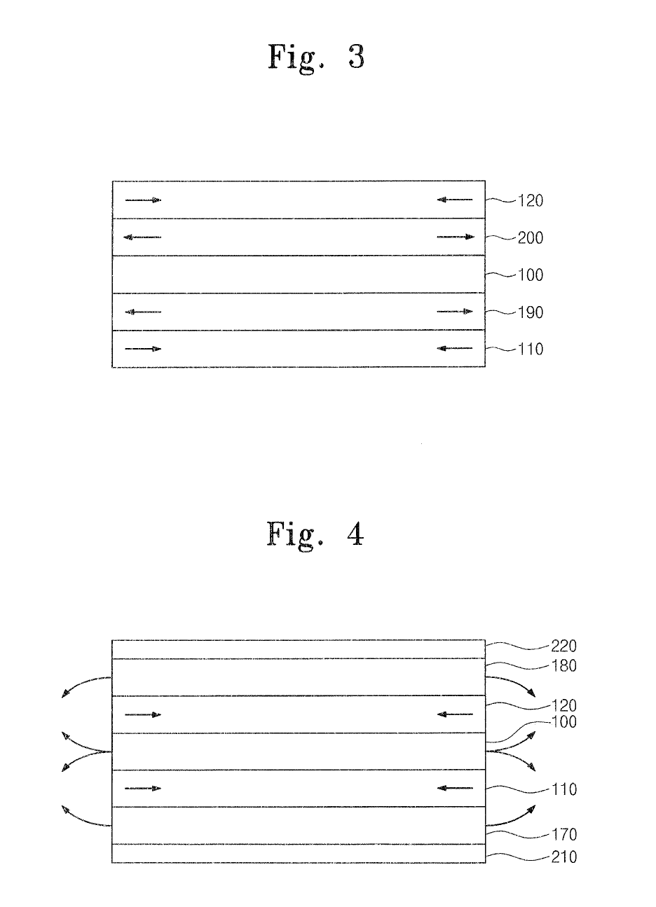

FIG. 3 is a sectional view of a display apparatus according to still other examplary embodiments of the present inventive concepts.

Referring to FIG. 3, a display apparatus may include a display panel 100, first and second polarizing films 110 and 120 disposed on both surfaces of a display panel 100, a first stress relieving adhesive layer 190 disposed between the display panel 100 and the first polarizing film 110 to serve as a first stress relieving member, and a second stress relieving adhesive layer 200 disposed between the display panel 100 and the second polarizing film 120 to serve as a second stress relieving member.

The first and second stress relieving adhesive layers 190 and 200 may include a pressure sensitive adhesive (PSA), which may be a material capable of adhering to two surfaces in contact therewith in response to an external physical force. In some embodiments, adhesion of the pressure sensitive adhesive may be achieved by attraction or absorption of molecules, atoms or ions thereof in response to an external physical force.

Table 1 shows deformation rates of the display panel 100 according to adhesive strengths of the first and second stress relieving adhesive layers 190 and 200. In the Table 1, the deformation rates of the display panel 100 are represented as as a percentage of the deformation measurable in a comparative example.

TABLE 1
Deformation (of the display panel) vs. Adherence (of the adhesive layer)

| | Adhesive strength (gf/mm) | Deformation (%) |
|---|---|---|
| Comparative Example 1 | No adhesive layer | 100 |
| Experimental Example 1 | 52 | 80 |
| Experimental Example 2 | 23.84 | 23 |
| Experimental Example 3 | 12 | 10 |
| Experimental Example 4 | 8 | 8 |

Referring to the Table 1, the deformation of the display panel 100 decreased with decreasing adhesive strength of the first and second stress relieving adhesive layers 190 and 200. For example, when the first and second stress relieving adhesive layers 190 and 200 had an adhesive strength of 12 gf/mm or less, the deformation rate of the display panel 100 was reduced to 10% or less.

This is because, when the first and second stress relieving adhesive layers 190 and 200 have an adhesive strength of 12 gf/mm or less, the restoring force from the first and second polarizing films 110 and 120 can be effectively relieved by the first and second stress relieving adhesive layers 190 and 200, and the restoring force exerted on the display panel 100 can be minimized. In addition, when the first and second stress relieving adhesive layers 190 and 200 have an adhesive strength higher than 12 gf/mm, the display panel 100 may be strongly adhered to the polarizing films 110 and 120, such that the restoring force from the first and second polarizing films 110 and 120 may be strongly exerted on the display panel 100.

In other words, in the case in which the first and second stress relieving adhesive layers 190 and 200 may have a low adhesive strength (especially, less than 12 gf/mm), it is possible to alleviate the restoring force exerted on the display panel 100.

FIG. 4 is a sectional view of a display apparatus according to yet further examplary embodiments of the inventive concepts of the present invention.

Referring to FIG. 4, the display apparatus may include a display panel 100, first and second polarizing films 110 and 120 disposed on both surfaces of a display panel 100, and first and second stress offsetting layers 170 and 180 serving as stress relieving members. In some embodiments, the first and second stress offsetting layers 170 and 180 can be disposed on facing surfaces of the first and second polarizing films 110 and 120 opposite from those surfaces in contact with the display panel 100.

The first and second stress offsetting layers 170 and 180 may be formed of un-stretched transparent films. For example, the first and second stress offsetting layers 170 and 180 may include at least one transparent film selected from the group consisting of polyethylene terephthalate (PET) materials, acrylic materials, and equivalents thereof.

Alternatively, the first and second stress offsetting layers 170 and 180 may be formed by coating or depositing a transparent material. For example, the first and second stress offsetting layers 170 and 180 can be organic transparent layers (for example, formed of at least one selected from the group consisting of polyimide (PI), parylene, polymethly methacrylate (PMMA), polyvinylalcohol (PVA), polyvinylphenol (PVP), and equivalents thereof) coated on the first and second polarizing films 110 and 120.

In addition, the first and second stress offsetting layers 170 and 180 can be transparent deposition layers (for example, formed of at least one selected from the group consisting of amorphous silicon (a-Si), silicon nitride (SiNx), and equivalents thereof) deposited on the first and second polarizing films 110 and 120.

The display apparatus may further include a first protection film 210, which is disposed on a surface of the first stress offsetting layer 170 opposite the first polarizing film 110, and a second protection film 220, which is disposed on a surface of the second stress offsetting layer 180 opposite the second polarizing film 120. The first and second protection films 210 and 220 can be at least one transparent film selected from the group consisting of polyethylene terephthalate (PET) materials, acrylic materials, and equivalents thereof.

Hereinafter, a method of relieving the restoring force of the stretched polarizing film will be explained.

The first and second polarizing films 110 and 120 can be uni-axially or bi-axially stretched by subjecting the requisite film to one or more stretching treatment(s) and then attaching said film(s) on incident and/or emitting surfaces of the display panel 100.

As the result of the stretching treatment, the first and second polarizing films 110 and 120 may have a restoring force serving as a stress exerted on the display panel 100. In this case, the display panel 100 may be deformed, such that a light incident into or emitted from the display panel 100 may be deflected. This phenomenon will be referred to herein as a deformation of the display panel 100.

The first and second stress offsetting layers 170 and 180 may be attached on the first and second polarizing films 110 and 120 to reduce a stress exerted on the display panel 100 by the first and second polarizing films 110 and 120.

In more detail, the first and second stress offsetting layers 170 and 180 may relieve the restoring force of the first and second polarizing films 110 and 120. For example, the first and second stress offsetting layers 170 and 180 may be fixedly attached to the first and second polarizing films 110 and 120 to prevent the first and second polarizing films 110 and 120 from contracting. In addition, the first and second stress offsetting layers 170 and 180, may exert a pressure on the first and second polarizing films 110 and 120 along a direction toward the display panel 100. This prevents the display panel 100 from being deformed by unbalanced stresses.

Due to the presence of the first and second protection films 210 and 220, the restoring force from the first and second polarizing films 110 and 120 can be effectively relieved.

As a result, in the display apparatus according to the present embodiment, it is possible to prevent the display panel 100 from being deformed.

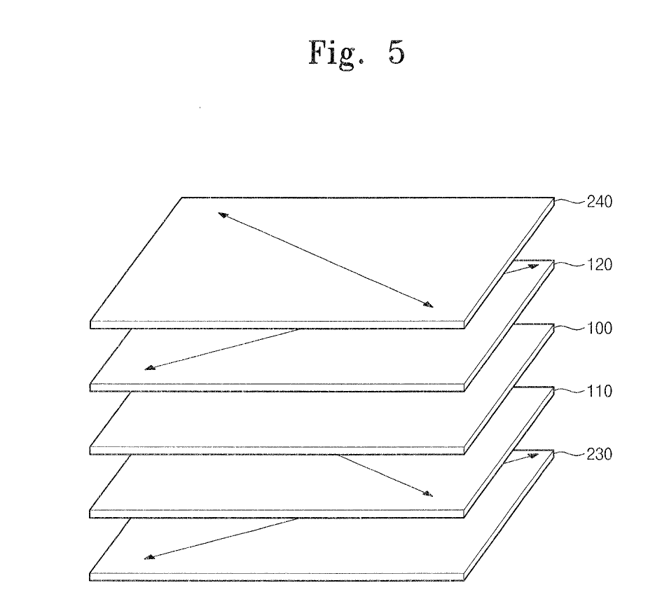

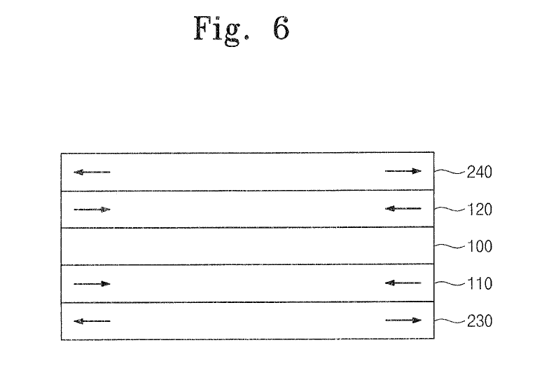

FIG. 5 is an exploded perspective view of a display apparatus according to yet other example embodiments of the inventive concepts, and FIG. 6 is a sectional view of the display apparatus of FIG. 5.

Referring to FIGS. 5 and 6, the display apparatus may include a display panel 100, first and second polarizing films 110 and 120 disposed on opposite surfaces of the display panel 100, a fifth stress relieving member 230 disposed on a surface of the first polarizing film 110 opposite the display panel 100, and a sixth stress relieving member 240 disposed on a surface of the second polarizing film 120 opposite the display panel 100.

As shown in FIG. 6, the fifth and sixth stress relieving members 230 and 240 may be configured to generate a resistive force against the restoring force of the first polarizing film 110.

For example, the fifth and sixth stress relieving members 230 and 240 may be transparent films generating restoring forces antiparallel to the restoring force from the first and second polarizing films 110 and 120. In more detail, the fifth stress relieving member 230 may be stretched along a direction perpendicular to a stretching direction of the first polarizing film 110 to relieve the restoring force from the first polarizing film 110. In addition, the sixth stress relieving member 240 may be stretched along a direction perpendicular to a stretching direction of the second polarizing film 120 to relieve the restoring force from the second polarizing film 120.

The first and second polarizing films 110 and 120 may be configured in such a way that their stretching directions are substantially perpendicular to each other. For example, the first polarizing film 110 and the sixth stress relieving member 240 may be disposed to have stretching directions parallel to each other and the second polarizing film 120 and the fifth stress relieving member 230 may be disposed to have stretching directions parallel to each other.

The fifth and sixth stress relieving members 230 and 240 may include a transparent material, such as polyethylene terephthalate (PET) materials, such that a light can be transmitted therethrough.

According to the above-mentioned example embodiments of the present inventive concepts, the display apparatus can include the fifth and sixth stress relieving members 230 and 240, which can relieve the restoring force resulting from the stretching of the first and second polarizing films 110 and 120. As a result, it is possible to prevent the display panel 100 from being deformed by the restoring force of the stretched film.

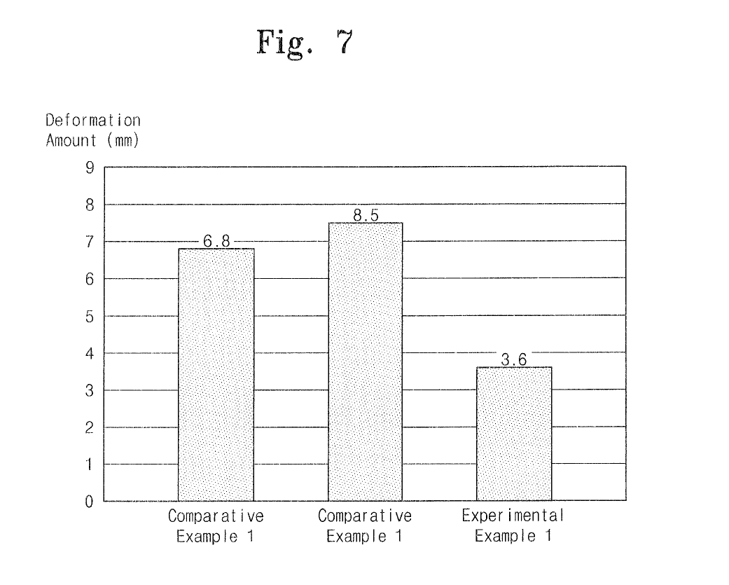

FIG. 7 is a graph showing deformation characteristics measured from display apparatus.

Referring to FIG. 7, comparative example 1 shows a deformation amount measured from a display panel including only the first and second polarizing films 110 and 120 attached on incident and emitting surfaces thereof. For the display panel of the comparative example 1, one surface of the display apparatus was about 6.8 mm higher or lower than the other surface of the display panel measured from the center of the display panel 100.

A comparative example 2 shows a deformation amount measured from a display panel with the first and second polarizing films 110 and 120, which was maintained in a temperature of about −20° C. for 24 hours. For the comparative example 2, the deformation amount was about 8.5 mm. That is, the deformation amount of a display panel was greater in the comparative example 2 than in the comparative example 1. This was because the first and second polarizing films 110 and 120 were contracted due to the cooling treatment and the contraction of the first and second polarizing films 110 and 120 acted as a restoring force exerted on the display panel 100.

An experimental example 1 shows a deformation amount measured from a display panel, which was configured to further include the stress relieving members 130 and 140 provided on the display panel of the comparative example 1. In the experimental example 1, the stress relieving members 130 and 140 were attached on the first and second polarizing films 110 and 120 and were formed of polyethylene terephthalate. For the experimental example 1, the deformation amount was about 3.6 mm. In other words, the deformation amount of the display panel according to the experimental example 1 was greatly reduced, compared with the comparative examples 1 and 2. This was because the restoring force from the first and second polarizing films 110 and 120 was relieved by the stress relieving members 130 and 140.

Accordingly, this means that display apparatus with the stress relieving members 130 and 140 can have an improved deformation property, compared with display apparatus lacking stress relieving members 130 and 140.

According to example embodiments of the inventive concepts, the display apparatus can include at least one stress relieving member capable of relieving a restoring force of a stretched polarizing film and therefore preventing deformation of the display apparatus.

While example embodiments of the inventive concepts have been particularly shown and described, it will be understood by one of ordinary skill in the art that variations in form and detail may be made therein without departing from the spirit and scope of the attached claims.

What is claimed is:

1. A display apparatus, comprising:
a display panel configured to display an image, the display panel having a first side and a second side;
a first polarizing film disposed on the first side of the display panel;
a second polarizing film disposed on the second side of the display panel;
a first stress relieving member interposed between the first polarizing film and the display panel to oppose a restoring force from the first polarizing film; and
a second stress relieving member interposed between the second polarizing film and the display panel to oppose a restoring force from the second polarizing film.

2. The display apparatus of claim 1, further comprising:
a third stress relieving member disposed on a surface of the first polarizing film opposite the display panel; and
a fourth stress relieving member disposed on a surface of the second polarizing film opposite the display panel.

3. The display apparatus of claim 2, wherein the first to fourth stress relieving members have a thickness thicknesses ranging from about 30 μm to about 250 μm.

4. The display apparatus of claim 3, wherein the first and second stress relieving members are thinner than the third and fourth stress relieving members.

5. The display apparatus of claim 4, wherein the first stress relieving member has a thickness less than half that of the third stress relieving member and the second stress relieving member has a thickness less than half that of the fourth stress relieving member.

6. The display apparatus of claim 2, wherein the first to fourth stress relieving members is a layer formed by coating at least one selected from the group consisting of triacetyl cellulose materials and cycloolefin polymer materials.

7. The display apparatus of claim 2, wherein the third and fourth stress relieving members are stress offsetting layers configured to cancel the restoring forces from the first and second polarizing films.

8. The display apparatus of claim 7, wherein the third and fourth stress relieving members include a transparent film selected from the group consisting of polyethylene terephthalate materials and acrylic materials.

9. The display apparatus of claim 7, wherein the third and fourth stress relieving members include at least one organic transparent layer selected from the group consisting of polyimide (PI), parylene, polymethly methacrylate (PMMA), polyvinylalcohol (PVA) and polyvinylphenol (PVP).

10. The display apparatus of claim 1, wherein the first and second stress relieving members are adhesive layers including a pressure sensitive adhesive material.

11. The display apparatus of claim 10, wherein the first and second stress relieving members have an adhesive strength of 12 gf/mm or less.

12. A display apparatus, comprising:
a display panel configured to display an image;
a first polarizing film disposed on one surface of the display panel;
a second polarizing film disposed on other surface of the display panel;
a first stress relieving member disposed on a surface of the first polarizing film opposite to the display panel; and
a second stress relieving member disposed on a surface of the second polarizing film opposite to the display panel.

13. The display apparatus of claim 12, wherein the first and second stress relieving members are configured to generate resistive forces against the restoring forces generated from the first and second polarizing films, respectively.

14. The display apparatus of claim 13, wherein, in plan view, the first stress relieving member includes a thin film stretched along a direction perpendicular to a stretching direction of the first polarizing film and the second stress relieving member includes a thin film stretched along a direction perpendicular to a stretching direction of the second polarizing film.

15. The display apparatus of claim 14, wherein stretching directions of the first polarizing film and the second stress relieving member are parallel to each other, and stretching directions of the second polarizing film and the first stress relieving member are parallel to each other.

16. The display apparatus of claim 12, wherein the first and second stress relieving members include a transparent film selected from the group consisting of polyethylene terephthalate materials and acrylic materials.

17. The display apparatus of claim 12, wherein the first and second stress relieving members include at least one organic transparent layer selected from the group consisting of polyimide (PI), parylene, polymethly methacrylate (PMMA), polyvinylalcohol (PVA) and polyvinylphenol (PVP).

18. The display apparatus of claim 12, wherein the first and second stress relieving members include at least one layer selected from the group consisting of amorphous silicon (a-Si) and silicon nitride (SiNx).

19. The display apparatus of claim 12, further comprising:
a first protection film disposed on a surface of the first stress relieving member opposite the first polarizing film; and
a second protection film disposed on a surface of the second stress relieving member opposite the second polarizing film.

20. The display apparatus of claim 19, wherein the first and second protection films include a layer formed of at least one selected from the group consisting of polyethylene terephthalate materials and acrylic materials.
